(19) United States
(12) Patent Application Publication
(10) Pub. No.: US 2012/0181339 A1
(43) Pub. Date: Jul. 19, 2012

(54) BANK AND CREDIT CARDS WITH LIMIT INFORMATION ON THE FACE AND HAVING AN AREA FOR PROMOTION OR LOGO

(76) Inventor: Kazim CEYLAN, Istanbul (TR)

(21) Appl. No.: 13/333,075

(22) Filed: Dec. 21, 2011

(30) Foreign Application Priority Data
Jan. 19, 2011 (TR) 2010/08076

(51) Int. Cl. G06K 19/06; G06K 19/04

(52) U.S. Cl. 235/491; 235/494

(57) ABSTRACT

A pass or a cash, EC or credit card includes an embossed styled display element. The card provides access to at least one account, and has limit information on the face. The card also shows at least one date, a name, an expiry date and/or a card number—e.g. credit card number—that is proprietary; and an area for promotion or logo. The card is characterized in that the card has additionally a second display element which shows the card limit matching the proprietary date and the limit of the credit card or the individual card.

### CROSS-REFERENCE TO RELATED APPLICATIONS

Not applicable.

### STATEMENT REGARDING FEDERALLY SPONSORED RESEARCH OR DEVELOPMENT

Not applicable.

### NAMES OF THE PARTIES TO A JOINT RESEARCH AGREEMENT Not applicable.

### INCORPORATION-BY-REFERENCE OF MATERIALS SUBMITTED ON A COMPACT DISC

Not applicable.

### BACKGROUND OF THE INVENTION

1. Field of the Invention

The present invention relates to a pass or a cash, .EC or credit card providing access to at least one account, having limit information (5) on the face, at least one date (4), a name (3), an expiry date and/or a card number (2) (e.g. a credit card number) that is proprietary and an area for promotions or a logo (6).

2. Description of Related Art Including Information Disclosed Under 37 CFR 1.97 and 37 CFR 1.98.

These cards are in the form of a credit card. The credit card number of the card owner, the expiry date of the card and the owner's name are written on the face of the card, wherein these information are embossed. On the face of the card it is also shown the information of the bank that assigns the credit card number, a security code, signs, chips when required, a magnetic stripe and advertising applications.

In the use of the known cards, it has been deemed to be a disadvantage at dealings not to have the limit information of the credit card owner. Thus, the function of this invention is the presentation of a card with an advanced functionality.

BRIEF SUMMARY OF THE INVENTION

The subject of the invention is a pass or a cash, EC or credit card including an embossed styled display element. The card providing access to at least one account and having limit information on the face. The card shows at least one date, a name, an expiry date and/or a card number (e.g. credit card number) that is proprietary. Further, an area is provided for promotion or logo are provided. The present invention is characterized in that the card has additionally a second display element (8) which shows the card limit matching the proprietary date and the limit of the credit card or the individual card.

### BRIEF DESCRIPTION OF THE SEVERAL VIEWS OF THE DRAWINGS

The various aspects of the present invention will now be described by way of example with reference to the accompanying drawings, in which:

FIG. 1 is a schematic view of a USD limit bank card with the limit displayed on the face and having an area for promotional or logo.

FIG. 2 is a schematic view of a EUR limit bank card with the limit displayed on the face and having an area for promotional or logo.

FIG. 3 is a schematic view of a TRY limit bank card with the limit displayed on the face and having an area for promotional or logo.

FIG. 4 is a schematic view of a EUR limit card sample.

FIG. 5 is a schematic view of a TRY limit card sample.

FIG. 6 is a schematic view of a USD limit card sample.

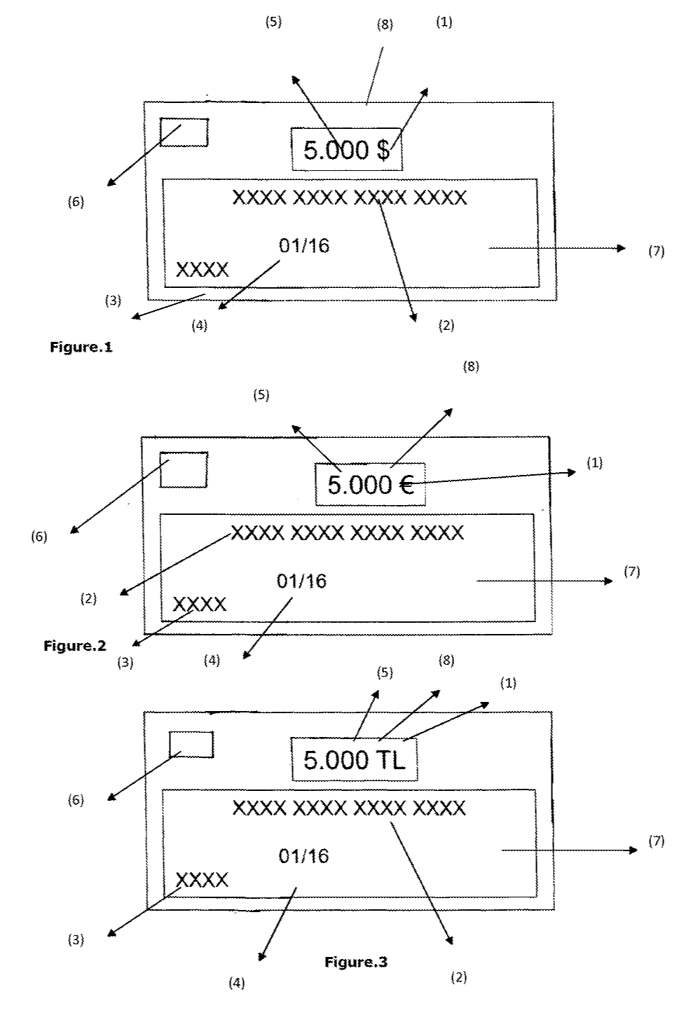

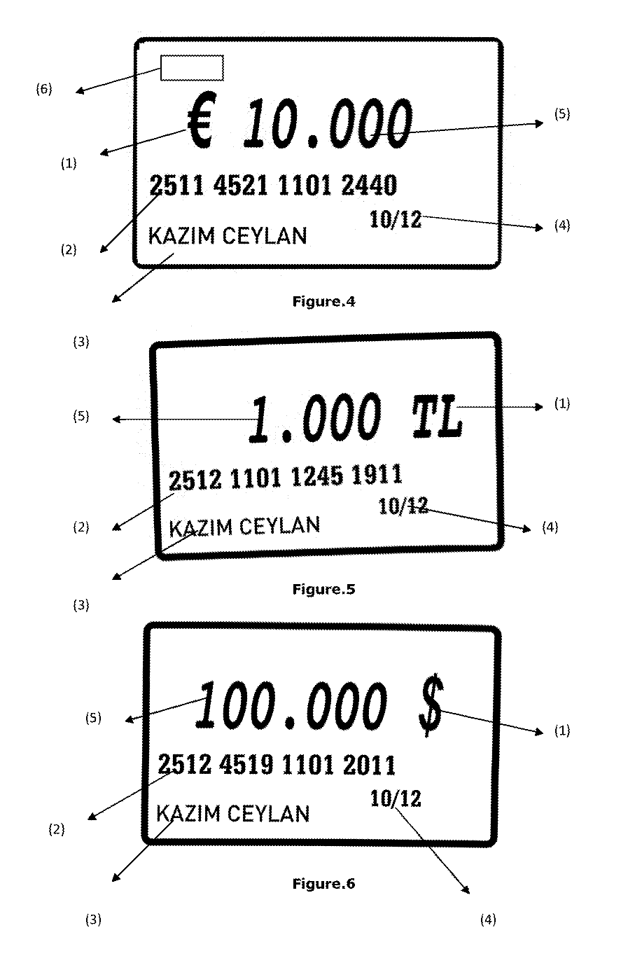

### DESCRIPTIONS OF THE NUMBERS EMBODIED ON THE FIGURES

(1): Currency unit information defined by signs or letters

(2): Card number information

(3): Card owner's information

(4): Expiry date information

(5): Card limit information defined by numbers and/or letters

(6): Advertisement or company logo

(7): First display element

(8): Second display element

### DETAILED DESCRIPTION OF THE INVENTION

In the present invention, there are at least two indicator elements, the first of which (7) shows the information of the card owner (3), the expiry date (4) and the card number (2). The latter (8), which can substantially be laid out at will, comprises the card limit information (5) composed of numbers or letters and the currency unit (2) particularized as letters or figures showing the limit.

It is all the same advantages that the second indicator element (8) includes embossed (particularly imprinted, gummed and/or engraved) numbers, letters and/or currency signs (1). Thus, the second indicator element (8) can be discerned not only visually but texturally also. The second indicator element (8) is, in this way, made to be both visible and tangible.

The numbers, letters (5) and/or currency signs (1) engraved and/or imprinted on the card body of the second indicator element (8) are a useful application as well. Thus, the second indicator element (8) can be distinguished not only visually but texturally also.

The numbers, letters (5) and/or currency signs (1) can be preferred as either embossed or engraved. Such fonts can be processed on the card in every type font, such as regular, italic, etc. Visual and textural perception increase by this way. Except for embossed and engraved process, limit information (5) may be written in phosphorated style as well. So, the users can easily see their limits even in the dark.

The length and shape of the numbers, letters and/or currency signs (1) can be modified at will. Different fonts and colors can also be used. However, that all the numbers, letters (5) and/or currency signs of the second indicator element (8) are at the same size or that all the numbers, letters (5) and/or currency signs (1) are at the different size provides an advantage.

It is herein considered to be more appropriate that all the numbers are at the same size and that all the letters are at the same size as well. A consistent visual perception is by this way created.

Besides, it is also suggested for improving the invention that the second indicator element (8) is located at the top or bottom, or at the right side or left side of the first indicator element (7).

The second indicator element (8) may substantially be set in anywhere of the card. Even so, it is preferred to locate the first and second indicator elements (7-8) on the same face of the card or on the opposite faces. It is easier to see both display elements when the first and second display elements (7-8) are placed on the same face of the card.

The second display element (8) further has an advantage of comprising an electronic display and another specific display. The information provided with the second display element (8) can be modified through this display.

It may substantially be considered to set an additional energy source on the card body as well. The display may be fed with the electronic energy through it. However, the electronic display is preferred to be fed with the electronic energy when the card is inserted into the reader, which keeps the card durable. Furthermore, the second display presents information only when it is used at dealings and especially when the reader is inserted into the device.

The second display (8) also provides an advantage of summoning updated account information. This subject may include the current card limit also.

The subject of the invention is that the card limit is registered as currency signs, numbers or words to all of the credit cards used by the banks.

The credit card limits valid today are not submitted with numbers or words. There is included the information, security code and signs of the bank that assigned the card number and certain advertising applications on the face of the card. However, today, the factor of statute or prestige is considered to be of great importance. People want to feel special and want to see their credit values while using their credit cards at dealings.

The present invention gives a clear demonstration of current limits through numbers on the credit card. People normally enjoy to make payment and want to show it. Most of the credit card owners will therefore be attracted to such a credit card (the credit card with the limit shown on its face).

### ADVANTAGES OF THE INVENTION

a) Visually impaired users can easily discern their limits and recognize their cards thanks to the embossed writing.

b) The users can easily see their limits even in the dark by dint of phosphorus writing of the limit, having a shining appearance at night.

c) By displaying the limits on the face of the card, people will not have to use the unchanging styled cards, which will also be personal and unusual.

d) The users will further benefit from another good point such as the presentation of the font styles (regular, italic, bond, etc) with a distinguished impression.

e) The users (especially those having high limit) will personally be satisfied with their limits being visible and will recognize their own credibilities.

f) A distinctive presentation and product will be activated, and with this product, only one card which is high limited and satisfying will come into use instead of several cards.

g) People may want to feel more special and prestigious at dealings or while making payment in everywhere credit cards are used. That the limits assigned by the banks can be seen as a consequence of commercial acquirements will make the users increase their reputations as well. It will even provide an ordinary person with an ability to act knowing his/her limit information.

The present invention is a cash, EC or credit card providing access to at least one account is shown on the figures. The card itself is particularly in the form of a usual card and displays on the face a proprietary date, the owner's name, the expiry date and/or the payment object number, e.g. the credit card number, which are written in embossed style. Numbers, letters or currency signs can be imprinted on the card body as embossing or printing.

Further, the card displays the card limit (5) matching the proprietary date and the limit of the credit card or the individual card.

In the schematic sample of the FIG. 1, the second display element (8) may include either numbers or letters and/or currency signs, which can be placed on the card body (4) in an embossed or engraved style.

The numbers, letters (5) and/or currency signs (1) of the second display element (8) may be at the same size as the numbers, letters (5) and/or currency signs (1) of the first display element (6). In the application samples shown on the figures, the numbers, letters and/or currency signs are bigger than those of the first display element (6).

The first display element (6) and the second display element (8) are placed on the same face of the card body (4).

The features of the invention submitted both in the description above and in the claims and drawings may serve as basis for various applications and to actuate the invention both solely and in different combinations.

1. A pass or a cash, EC or credit card including an embossed styled display element; providing access to at least one account, having limit information on the face; at least one date, a name, an expiry date and/or a card number—e.g. credit card number—that is proprietary; and an area for promotion or logo; characterized in that the card has additionally a second display element which shows the card limit matching the proprietary date and the limit of the credit card or the individual card.

2. The card as claimed in claim I, characterized in that the second display element on the card body includes embossed, particularly imprinted, gummed and/or engraved, numbers, letters and/or currency signs.

3. The card as claimed in claim, characterized in that the display element on the card body includes engraved, particularly imprinted, gummed and/or engraved, numbers, letters and/or currency signs.

4. The card as claimed in claim 1, characterized in that the display element on the card body includes phosphorous numbers, letters and/or currency signs.

5. The card as claimed in claim 1, characterized in that the numbers, letters and/or currency signs of the second display element are at the same size as or bigger or smaller than those of the first display element.

6. The card as claimed in claim 1, characterized in that all of or most of the numbers, letters and/or currency signs of the second display element include the same size or that all of or most of the numbers, letters and/or currency signs of the second display element include different sizes.

7. The card as claimed in claim 1, characterized in that the second display element is placed at the top or bottom or at the right or left side of the first display element.

8. The card as claimed in claim 1, characterized in that the first and the second display elements are located on the same face of the card or on the opposite faces.

9. The card as claimed in claim 1, characterized in that the second display element includes an electronic display and another specific display.

10. The card as claimed in claim 7, characterized in that the electronic display is fed with electronic energy when the card is inserted into a reader.

11. The card as claimed in claim 1, characterized in that at user's will, the card can be made distinctive thereby having an area for image and/or logo on the face.
